(19) United States
(12) Patent Application Publication
(10) Pub. No.: US 2006/0224737 A1
(43) Pub. Date: Oct. 5, 2006

(54) Method for forming super frame used for transmitting isochronous data and asynchronous data in residential Ethernet system

(75) Inventors: Jae-Hun Cho, Seoul (KR); Jong-Ho Yoon, Goyang-si (KR); Sang-Ho Kim, Hwaseong-si (KR); Sihai Wang, Suwon-si (KR); Yun-Je Oh, Yongin-si (KR); Jun-Ho Koh, Suwon-si (KR); Hee-Kyung Choi, Goyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/374,795

(22) Filed: Mar. 14, 2006

(30) Foreign Application Priority Data
Mar. 14, 2005 (KR) 2005-21187

(51) Int. Cl. G06F 15/173

(52) U.S. Cl. 709/225

(57) ABSTRACT

Disclosed is a method for forming a super frame used for transmitting isochronous data and asynchronous data in a residential Ethernet system. The method includes the steps of receiving the isochronous data and the asynchronous data to be transmitted through the residential Ethernet system, forming an isochronous frame using the received isochronous data, forming a cycle start frame used for reporting start of the super frame, and inserting the asynchronous data into an area of an asynchronous frame by employing a remaining area as the area of the asynchronous frame, the remaining area being obtained by excluding an isochronous frame area, which includes the cycle start frame and the isochronous frame, from an area having the predetermined size.

### CLAIM OF PRIORITY

This application claims priority to an application entitled “Method for Forming Super Frame Used For Transmitting Isochronous Data and Asynchronous Data In Residential Ethernet System” filed with the Korean Intellectual Property Office on Mar. 14, 2005 and assigned Serial No. 2005-21187, the contents of which are incorporated herein by reference.

### BACKGROUND OF THE INVENTION

1. Field of the Invention

The present invention relates to a residential Ethernet, and more particularly to a method for forming a super frame used for transmitting isochronous data and asynchronous data in a residential Ethernet system.

2. Description of the Related Art

Ethernet is the most widely constructed local-area network (LAN) technique. Although the Ethernet is currently defined in the Institute of Electrical and Electronics Engineers (IEEE) 802.3 standard, it was originally developed by Xerox Corporation, and has been developed by Xerox Corporation, DEC Corporation, and Intel Corporation among other companies. The Ethernet is the most popular technique used for transmitting data between different terminals or users

Since frames competitively access the Ethernet based on a carrier sense multiple access/collision detect protocol (CSMA/CD) defined in the IEEE 802.3 protocol standard, the conventional Ethernet converts the upper layer service frames into Ethernet frames to be transmitted while maintaining an inter-frame gap (IFG). In this case, the upper layer service frames are transmitted in a frame occurrence sequence regardless of the type of the upper-layer service frames.

However, since Ethernet transmits Ethernet frames through a CSMA/CD scheme, in which the same priority is allocated to all Ethernet frames such that they are competitively transmitted, the Ethernet is not suitable for transmitting a moving picture or voice data sensitive to a transmission time delay.

Lately, as the transmission of the moving picture or the voice data has increased, and the moving picture or the voice data occupy great portions in data transmission, various schemes have been suggested for solving problems caused by the transmission delay in the Ethernet.

One of method for solving the transmission delay problem is referred to as the IEEE 802.3p technique. The IEEE 802.2p technique is a scheme for reducing a delay by assigning classification of service (COS) to data, such as multimedia data, which must be primarily transmitted, in the conventional Ethernet. Although the suggested IEEE 802.3p technique can reduce a time delay somewhat, as compared with the conventional IEEE 802.3Ethernet technique, by allocating priority to the multimedia data when the multimedia data are transmitted, the IEEE 802.3p technique requires a bandwidth manager for managing bandwidth allocation as there is no procedure of requesting and allocating bandwidth for each data. Thus, the size of a jitter buffer used to compensate for time delays must be increased in order to manage the bandwidth.

Another scheme is a Residential Ethernet which has been suggested for transmitting synchronous data and asynchronous data in one transmission cycle. The Residential Ethernet forms and transmits sub-synchronization frames having the same size by allocating slots having the same size to synchronous data.

FIG. 1 is a view illustrating the structure of a transmission cycle in the conventional Residential Ethernet.

According to the transmission cycle used in the conventional Residential Ethernet, one cycle 10 is established with 125 microsecond (μsec), and each cycle includes an asynchronous (Async) frame interval 110 for transmitting asynchronous data and a synchronous (Sync) frame interval 100 for transmitting synchronous data.

More specifically, the synchronous frame interval 100 for transmitting synchronous data has the highest priority in the transmission cycle. According to a scheme under discussion, the synchronous frame interval 100 includes 738-byte synchronous frames 101, 102, and 103. Although reference is made herein to a 738-byte synchronous frame interval, it would be recognized that this value need not be fixed and may be changeable based on the transmission protocol used.

The asynchronous frame interval 110 for transmitting asynchronous data includes sub-asynchronous frames 111, 112, and 113 having variable sizes.

FIG. 2 is a view illustrating a structure of a sub-synchronous frame included in the transmission cycle of the conventional residential Ethernet.

The sub-synchronous frame of the conventional residential Ethernet consisting of 22 octets includes an Ethernet header 21 containing header information regarding a destination address, a source address, a type, of an Ethernet frame, a synchronous (Sync) header 22 consisting of 32 bytes and containing synchronization frame information such as synchronization state information, frame counter information, cycle counter information, etc, a header check sequence (HCS) 23 for determining the header information, a synchronous data slot 24 having the length of 768 bytes and including 192 4-byte synchronization data slots so as to contain synchronous Ethernet data to be transmitted, and a frame check sequence (FCS) 25 for detecting transmission errors.

In addition, the synchronous data slot 24 includes a set of 4-byte data slots 241 and 242, in which each of synchronization Ethernet data is discretely transmitted through the 4-byte data slots 241 and 242.

In this case, when synchronous Ethernet data are transmitted to each user from a server, the synchronous data slot 24 contains synchronization Ethernet data for all users in the form of a slot. Accordingly, since the synchronization Ethernet data cannot be transmitted to each user through a uni-cast scheme, the synchronization Ethernet data must be transmitted to each user through a multi-cast scheme, so each user's equipment must process its own data from the data slots.

Furthermore, the destination address included in the Ethernet header 21 is used for representing an Ethernet switch for the final routing instead of a destination address of each Ethernet synchronization data. Accordingly, the destination address included in the Ethernet header 21 is different from a destination address of Ethernet synchronization data, which specifies each user.

The conventional Residential Ethernet system must perform slot data processing with respect to each synchronous data. However, a procedure of inserting the synchronous data into a data area of the sub-synchronization frame by processing the synchronous data into the slot data is very complex. In addition, even if the slot data are inserted into the data area through the above procedure, the data area inside of the sub-synchronization frame must be managed in order to perform slot routing and slot reservation with respect to the slot data.

Furthermore, if the middle area of the sub-synchronization frame is not used when the synchronous data are processed into the slot data, bandwidth may seriously be wasted.

In addition, since the whole synchronization frame interval must be transmitted to each user, unnecessary data may be transmitted to users, so bandwidth for each user may be wasted.

### SUMMARY OF THE INVENTION

Accordingly, the present invention has been made to solve the above-mentioned problems occurring in the prior art and provides additional advantages, by providing a method of forming a super frame for transmitting isochronous data and asynchronous data in a residential Ethernet system in such a manner that the synchronous data can be individually transmitted to each user without being processed into slot data.

Another aspect of the present invention is to provide a method for transmitting synchronous data without jitter by managing synchronous data and distributing bandwidth between the synchronous data in a Residential Ethernet system which can transmit the synchronous data without delay.

In one embodiment, there is provided a method for forming a super frame having a predetermined size used for transmitting isochronous data and asynchronous data in a residential Ethernet system, the method including the steps of receiving the isochronous data and the asynchronous data to be transmitted through the residential Ethernet system, forming an isochronous frame using the received isochronous data, forming a cycle start frame used for reporting start of the super frame, and inserting the asynchronous data into an area of an asynchronous frame by employing a remaining area as the area of the asynchronous frame, the remaining area being obtained by excluding an isochronous frame area, which includes the cycle start frame and the isochronous frame, from an area having the predetermined size.

### BRIEF DESCRIPTION OF THE DRAWINGS

The above features and advantages of the present invention will be more apparent from the following detailed description taken in conjunction with the accompanying drawings, in which:

FIG. 1 is a view illustrating the structure of a transmission cycle in a conventional residential Ethernet;

FIG. 2 is a view illustrating structure of a sub-synchronous frame included in a transmission cycle of a conventional residential Ethernet;

FIG. 3 is a view illustrating the structure of a transmission cycle of a residential Ethernet in accordance with the present invention;

FIG. 4 is a view illustrating the structure of a Residential Ethernet switch according to an embodiment of the present invention;

FIG. 5 is a view of a procedure for transmitting isochronous data in a residential Ethernet system according to a first embodiment of the present invention;

FIG. 6 is a view of a procedure for transmitting isochronous data in a residential Ethernet system according to a second embodiment of the present invention; and

FIG. 7 is a view of a procedure for transmitting isochronous data in a residential Ethernet system according to a third embodiment of the present invention.

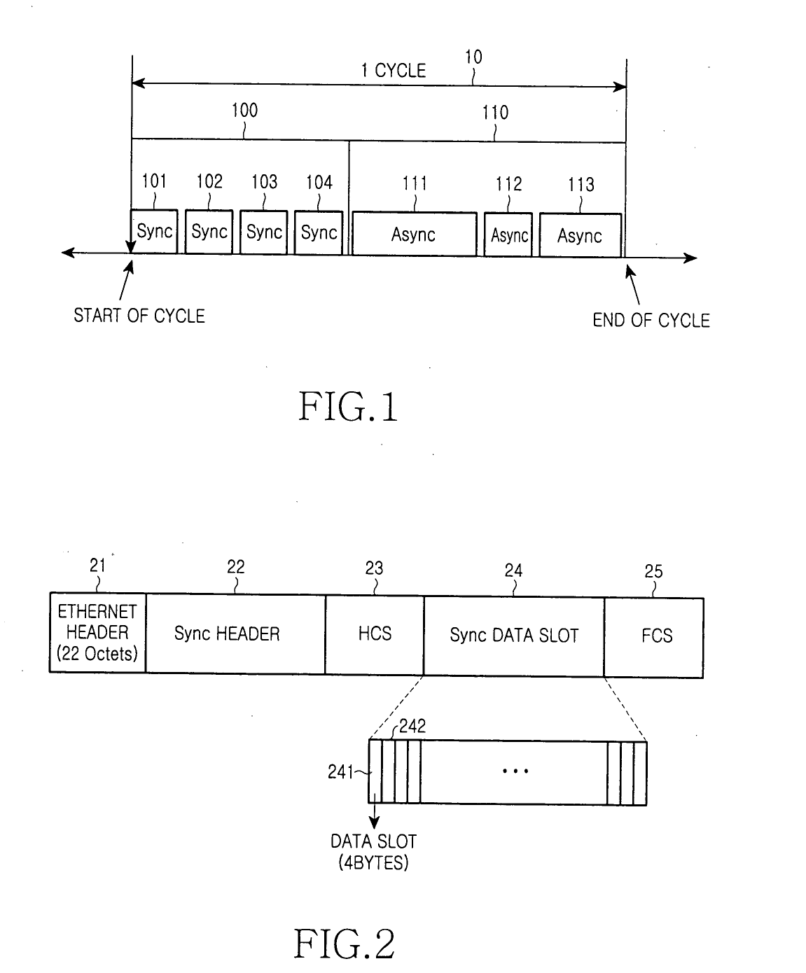

### DETAILED DESCRIPTION OF THE INVENTION

Hereinafter, embodiments of the present invention will be described in detail with reference to the accompanying drawings. Note that the same or similar components in drawings are designated by the same reference numerals as far as possible although they are shown in different drawings. For the purposes of clarity and simplicity, a detailed description of known functions and configurations incorporated herein will be omitted when it may make the subject matter of the present invention unclear.

According to the present invention, a synchronization frame interval processed into slot data used in the conventional residential Ethernet is formed in such a manner that the synchronization frame interval is packetized according to destinations, synchronization packets are formed according to various sizes, and routing is achieved according to the synchronization packets.

This will be described below with reference to the accompanying drawings.

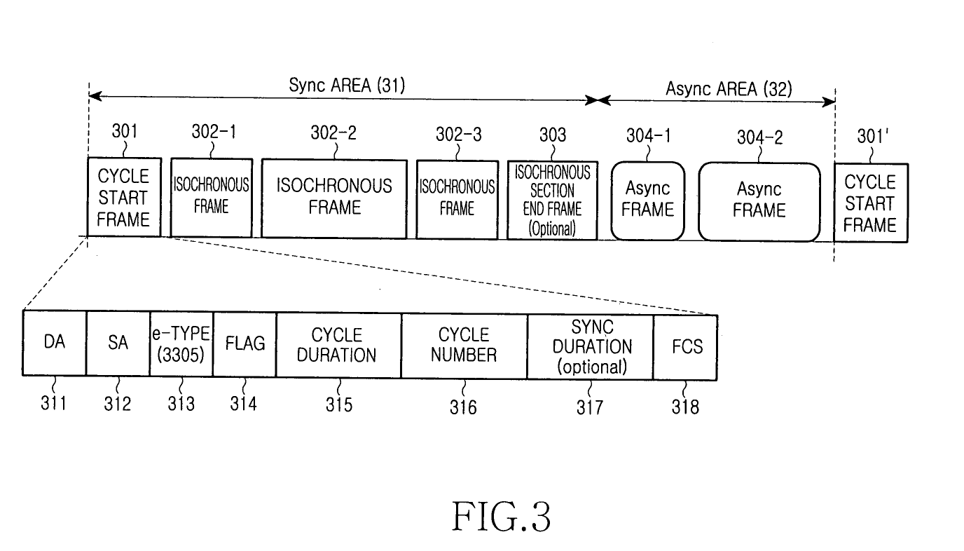

FIG. 3 is a view illustrating the structure of a transmission cycle in a Residential Ethernet suggested in the present invention.

The transmission cycle of the Residential Ethernet suggested in the present invention as shown in FIG. 3 includes a super frame based on one cycle of 125 μsec, and each super frame includes an asynchronous area 32 for transmitting asynchronous data and a synchronous area 31 for transmitting synchronous data.

In more detail, the synchronous area 31 for transmitting synchronous data has the highest priority in the transmission cycle and includes a cycle start frame 301, a plurality of isochronous frames 302-1, 302-2, and 302-3, and an optional isochronous section end frame 303 according to an embodiment of the present invention even though a synchronous area in the conventional residential Ethernet includes sub-synchronous frames having the same size.

The conventional sub-synchronization frames can be marked as synchronous sub-frames using their synchronous headers. However, according to the present invention, a plurality of isochronous frames 302-1, 302-2, and 302-3 are formed as typical Ethernet packets, so there is no scheme for marking the isochronous frames as synchronous sub-frames. Thus, after notifying the start point of synchronous area through the cycle start frame 301, the end point of the synchronous area is notified through the isochronous section end frame 303 in such a manner that frames existing between the start point and end point of synchronous area can be marked as isochronous frames.

Although the conventional Residential Ethernet transmission cycle has a structure in which a sub-synchronization frame includes a multi-payload, a Residential Ethernet transmission cycle according to an embodiment of the present invention has a structure in which each of isochronous frames 302-1, 302-2, and 302-3 individually includes a payload having one destination address. Therefore, according to an embodiment of the present invention, a typical Ethernet packet is employed as an isochronous frame.

In order to provide the isochronous frame, according to an embodiment of the present invention, a special frame such as a beacon frame of a wireless LAN is formed so as to indicate the start of the synchronous area 31. A frame similar to this beacon frame is referred to as a cycle start frame 301.

The cycle start frame 301 includes a destination address (DA) field 311 used for representing a destination address, a source address (SA) field 312 used for representing a source address, an E-type field 313 used for representing an Ethernet data type, a flag field 314 used for representing if a corresponding frame is the cycle start frame, a cycle duration field 315 used for representing the duration of a cycle, that is, the period of the cycle, a cycle number field 316 used for representing a cycle number of a current cycle, and a frame check sequence (FCS) field 318 used for detecting a transmission error of a frame.

The cycle start frame 301 additionally includes a synchronous duration field 317 used for reporting the range of the synchronous area 31. In this case, the isochronous section end frame 303 may be removed from the synchronous area 31. This is because the synchronous duration field 317 expresses the size of the synchronous area 31, so the end of the synchronous area 31 can be recognized even though the end of the synchronous area 31 is not expressed using the isochronous section end frame 303.

In the meantime, the asynchronous area 32 includes a plurality of asynchronous frames 304-1 and 304-2 similar to the conventional Residential Ethernet. Herein, the asynchronous frames 304-1 and 304-2 are called “Best Effort” frames because all packets are identically processed in a router according to the route determined based on a routing protocol. More specifically, the asynchronous are is determined by employing a remaining area as the area of the asynchronous frame, the remaining area being obtained by excluding an isochronous frame area, which includes the cycle start frame and the isochronous frame, from an area having the predetermined size.

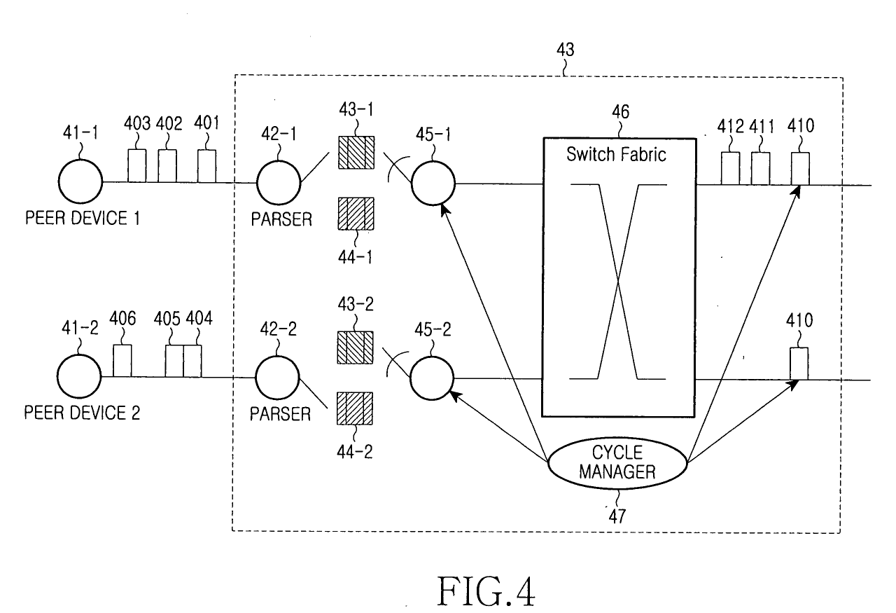

FIG. 4 is a view illustrating the structure of a Residential Ethernet switch 43 according to an embodiment of the present invention.

The Residential Ethernet switch 43 according to an embodiment of the present invention receives Residential Ethernet data including cycle start frames 401 and 404 from peer devices 41-1 and 41-2, respectively, switches the residential Ethernet data, and outputs the Residential Ethernet data by inserting a new cycle start frame 410 into the Residential Ethernet data. In other words, the Residential Ethernet switch 43 according to an embodiment of the present invention can output the Residential Ethernet data by synchronizing the Residential Ethernet data with each other through internal buffering even though the Residential Ethernet data are not synchronized with each other at the input ports.

With regard to the operation of the Residential Ethernet switch 43, the Residential Ethernet switch 43 according to an embodiment of the present invention receives the cycle start frames 401 and 404, isochronous frames 402 and 405, and asynchronous frames 403 and 406 from the peer devices 41-1 and 41-2, respectively. In this case, input ports of the Residential Ethernet switch 43 operate with independent cycles without requiring synchronization therebetween.

Then, the cycle start frames 401 and 404, the isochronous frames 402 and 405, and the asynchronous frames 403 and 406, which have been received, are parsed by means of parsers 42-1 and 42-2. The cycle start frames 401 and 404 are discarded, and the isochronous frames 402 and 405 and the asynchronous frames 403 and 406 are delivered to, and stored in, isochronous frame buffers 43-1 and 43-2 and asynchronous frame buffers 44-1 and 44-2, respectively.

Switching switches 45-1 or 45-2 to the isochronous frame buffers 43-1 and 43-2 or the asynchronous frame buffers 44-1 and 44-2 is controlled by means of a cycle manager 47 of the Residential Ethernet switch 43, and the new cycle start frame 410 is created with respect to an output signal switched by the switch fabric 46 such that the output signal switched by the switch fabric 46 can be output from the Residential Ethernet switch 43.

Accordingly, input ports of the Residential Ethernet switch 43 operate with independent cycles without requiring synchronization therebetween, and, when data are output, the residential Ethernet switch 43 becomes a cycle master so as to transmit a newly synchronized isochronous frame.

The above described method is suggested because the cycle start frames may collide with each other when data are transmitted/received between a plurality of Residential Ethernet devices, or when data including the cycle start frames are received from the Residential Ethernet devices and processed. This method is identically applicable to other Residential Ethernet devices as well as a Residential Ethernet switch. In other words, it is unnecessary to synchronize data with each other at the input ports of the Residential Ethernet device. However, at an inside of the Residential Ethernet device, it is necessary to synchronize the data with each other, by removing cycle start frames included in the input data and adding cycle start frames newly created by a corresponding residential Ethernet device to the data when the data are output.

It can be understood based on the above description that the synchronous area 31 includes isochronous frames having a typical Ethernet packet format. Each of the isochronous frames may have a variable length. There may exist two schemes for transmitting the isochronous frames according to the process of a destination address (DA).

One scheme processes addresses of all isochronous frames as multi-cast addresses, and the other scheme processes the isochronous frames in such a manner that the isochronous frames have different destination addresses.

In the case of the second scheme, a destination address of a corresponding isochronous frame becomes a multi-cast address only when a plurality of users simultaneously requires the isochronous frame with respect to the same source.

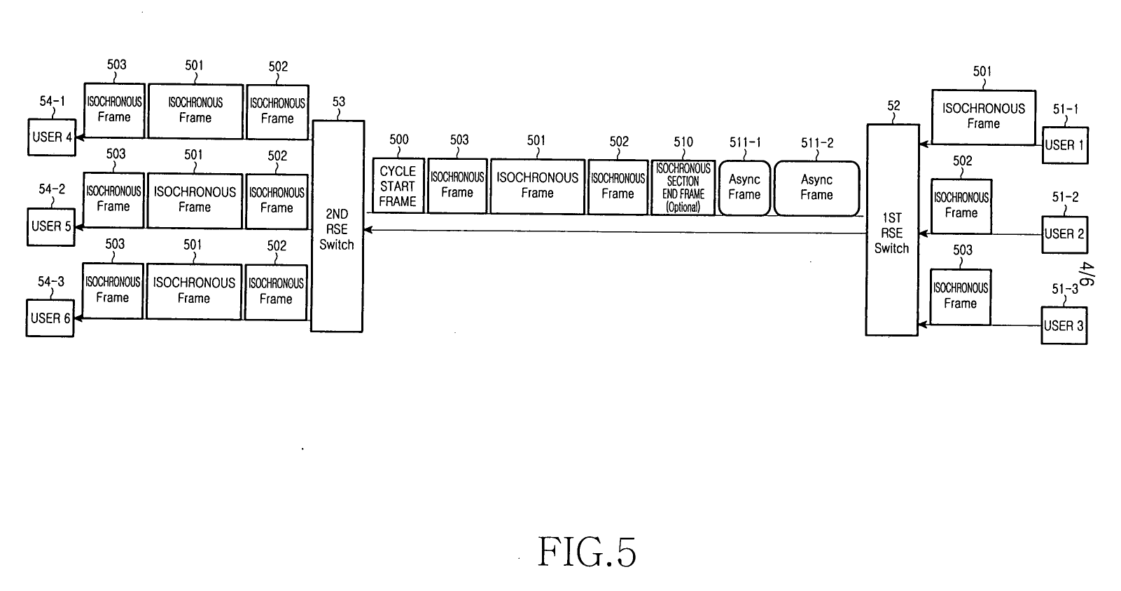

The transmission of isochronous data will be described with respect to FIGS. 5 to 7.

FIG. 5 is a view of a procedure for transmitting isochronous data in the Residential Ethernet system according to a first embodiment of the present invention.

The residential Ethernet system includes transmitter-side users 51-1, 51-2, and 51-3 which provide synchronous data and asynchronous data to be transmitted to receiver-side users 54-1, 54-2, and 54-3, respectively, a first residential Ethernet switch 52 which creates and transmits a Residential Ethernet transmission cycle according to the present invention, a second Residential Ethernet switch 53 which receives the created Residential Ethernet transmission cycle from the first Residential Ethernet switch 52 and delivers isochronous frames received for the receiver-side users 54-1, 54-2, and 54-3 according to destinations, respectively, and the receiver-side users 54-1, 54-2, 54-3, which receive and process the isochronous frames. Herein, the transmitter-side users 51-1, 51-2, and 51-3 and the receiver-side users 54-1, 54-2, and 54-3 refer to user equipment interfacing with users, and, for the purpose of the description, are referred-to as the users.

In the description about a procedure for transmitting isochronous data based on the structure, the transmitter-side users 51-1, 51-2, and 51-3 create isochronous data 501, 502, and 503 to be transmitted for the receiver-side users 54-1, 54-2, and 54-3 so as to deliver the isochronous data to the first Residential Ethernet switch 52. In this case, according to an embodiment of the present invention, the created isochronous data 501, 502, and 503 include typical Ethernet packets.

Furthermore, the first Residential Ethernet switch 52 builds a residential Ethernet transmission cycle according to the present invention using the delivered isochronous data 501, 502, and 503, and the Residential Ethernet transmission cycle according to the present invention includes a cycle start frame 500 for representing start of a cycle, a plurality of isochronous data 501, 502, and 503, an synchronous area end frame 510 for representing the end of the synchronous area, and asynchronous frames 511-1 and 511-2. In this case, the synchronous area end frame 510 may be omitted when the synchronous duration field 317 is included in the cycle start frame 500.

Then, the second Residential Ethernet switch 53 delivers isochronous data 501, 502 and 503 to the receiver-side users 54-1, 54-2, and 54-3 in a multi-cast scheme.

Since the description is given based on the transmission of isochronous data, transmission of asynchronous frames is neither described nor shown in the accompanying drawing. However, since it is generally known to those skilled in the art that the asynchronous frames are transmitted according to a typical transmission algorithm of an Ethernet packet, such a transmission of the asynchronous frame may be included within the scope of the present invention even though it is not described as a specific embodiment of the present invention.

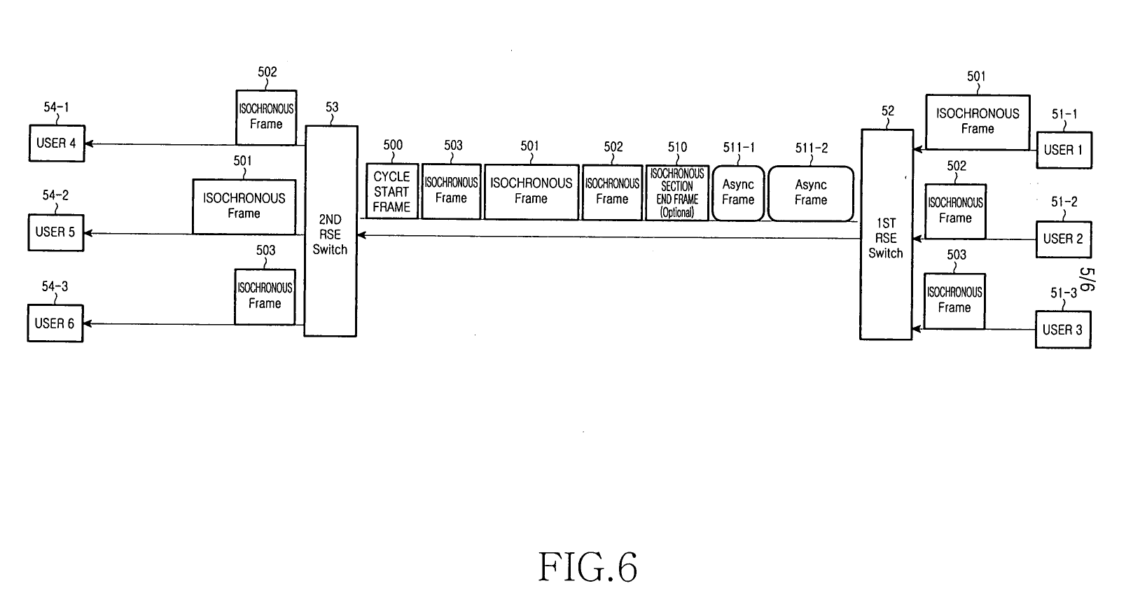

FIG. 6 is a view of a procedure for transmitting isochronous data in a Residential Ethernet system according to a second embodiment of the present invention.

The Residential Ethernet system includes transmitter-side users 51-1, 51-2, and 51-3 which provide isochronous data and asynchronous data to be transmitted to receiver-side users 54-1, 54-2, and 54-3, respectively, a first Residential Ethernet switch 52 which creates and transmits a Residential Ethernet transmission cycle according to the present invention, a second Residential Ethernet switch 53 which receives the created Residential Ethernet transmission cycle from the first Residential Ethernet switch 52 and delivers isochronous data received for the receiver-side users 54-1, 54-2, and 54-3 according to destinations, respectively, and the receiver-side users 54-1, 54-2, 54-3, which receive and process the isochronous data. Herein, the transmitter-side users 51-1, 51-2, and 51-3 and the receiver-side users 54-1, 54-2, and 54-3 refer to user equipment interfacing with users, and, for the purpose of the description, are referred-to as the users.

In the description about a procedure for transmitting isochronous data based on the structure, the transmitter-side users 51-1, 51-2, and 51-3 create isochronous data 501, 502, and 503 to be transmitted for the receiver-side users 54-1, 54-2, and 54-3 so as to deliver the isochronous data to the first residential Ethernet switch 52. In this case, according to this embodiment of the present invention, the created isochronous data 501, 502, and 503 have a typical Ethernet packet type.

Furthermore, the first Residential Ethernet switch 52 forms a Residential Ethernet transmission cycle according to the present invention using the delivered isochronous data 501, 502, and 503, and the Residential Ethernet transmission cycle according to the present invention includes a cycle start frame 500 for representing start of a cycle, a plurality of isochronous data 501, 502, and 503, an optional isochronous section end frame 510 for representing end of the isochronous area, and asynchronous frames 511-1 and 511-2. In this case, the isochronous section end frame 510 may be omitted when the synchronous duration field 317 is included in the cycle start frame 500.

Then, the Residential Ethernet switch 53 delivers isochronous data 501, 502 and 503 to the receiver-side users 54-1, 54-2, and 54-3 in a uni-cast scheme.

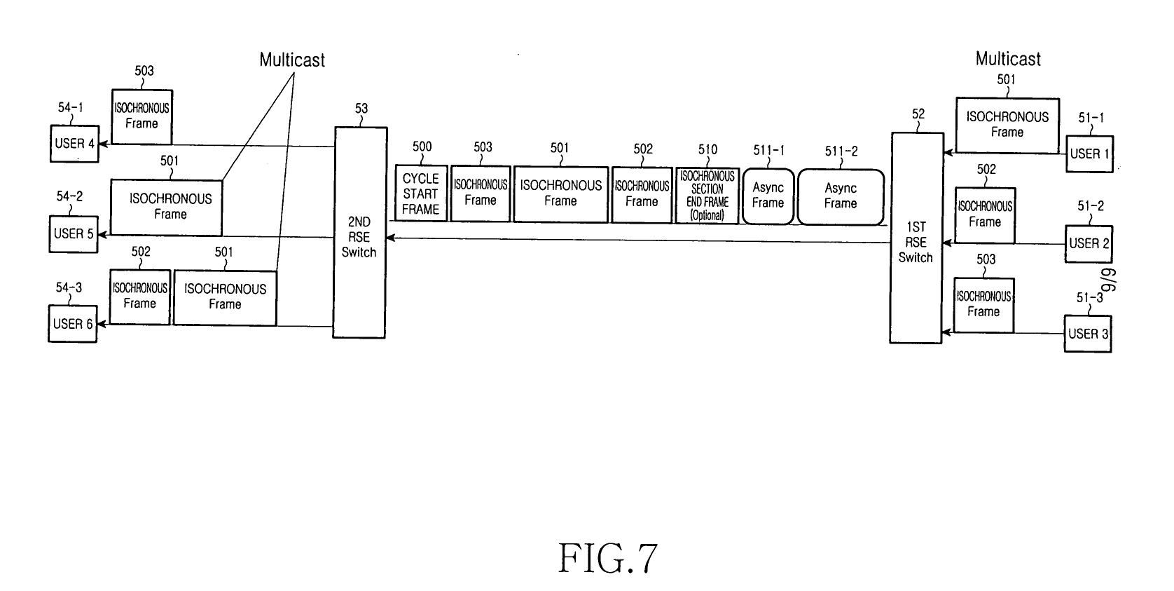

FIG. 7 is a view of a procedure for transmitting isochronous data in a Residential Ethernet system according to a third embodiment of the present invention.

The Residential Ethernet system includes transmitter-side users 51-1, 51-2, and 51-3 which provide isochronous data and asynchronous data to be transmitted to receiver-side users 54-1, 54-2, and 54-3, respectively, a first Residential Ethernet switch 52 which creates and transmits a Residential Ethernet transmission cycle according to the present invention, a Residential Ethernet switch 53 which receives the created residential Ethernet transmission cycle from the first Residential Ethernet switch 52 and delivers isochronous data received for the receiver-side users 54-1, 54-2, and 54-3 according to destinations, respectively, and the receiver-side users 54-1, 54-2, 54-3, which receive and process the isochronous data. Herein, the transmitter-side users 51-1, 51-2, and 51-3 and the receiver-side users 54-1, 54-2, and 54-3 refer to user equipment interfacing with users, and, for the purpose of the description, are referred-to as the users.

In the description about a procedure for transmitting isochronous data based on the structure, the transmitter-side users 51-1, 51-2, and 51-3 create isochronous data 501, 502, and 503 to be transmitted for the receiver-side users 54-1, 54-2, and 54-3 so as to deliver the isochronous data to the first residential Ethernet switch 52. In this case, according to an embodiment of the present invention, the created isochronous data 501, 502, and 503 have a typical Ethernet packet structure.

Furthermore, the first residential Ethernet switch 52 forms a residential Ethernet transmission cycle according to the present invention using the delivered isochronous data 501, 502, and 503, and the residential Ethernet transmission cycle according to the present invention includes a cycle start frame 500 for representing start of a cycle, a plurality of isochronous data 501, 502, and 503, an isochronous section end frame 510 for representing end of an isochronous area, and asynchronous frames 511-1 and 511-2. In this case, the isochronous section end frame 510 may be omitted when the synchronous duration field 317 is included in the cycle start frame 500.

Then, the second residential Ethernet switch 53 delivers isochronous data 501, 502 and 503 to the receiver-side users 54-1, 54-2, and 54-3 in a uni-cast scheme. In addition, the isochronous data 501 having multi-cast addresses are delivered to the receiver-side users 54-2 and 54-3 according to the multi-cast addresses.

As described above, the method of the present invention may be realized as a program and stored in storage media (CD ROM, RAM, a floppy disk, a hard disk, an optical magnetic disk, etc) or by delivered by a network such that it can be read by means of computers.

As described above, according to the present invention, information in isochronous area is defined as a beacon type in a residential Ethernet system, so it is possible to omit a synchronous header added to the isochronous frame of the conventional residential Ethernet system employing a slot reservation/routing scheme and form an isochronous frame using a typical Ethernet packet.

In addition, according to the present invention, it is possible to easily realize a slot routing scheme in a residential Ethernet system while quickly processing isochronous data.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments described herein, but should be defined by the appended claims and equivalents thereof.

What is claimed is:

1. A method for forming a super frame having a predetermined size used for transmitting isochronous data and asynchronous data in a residential Ethernet system, the method comprising the steps of:
(1) receiving the isochronous data and the asynchronous data to be transmitted through the residential Ethernet system;
(2) forming an isochronous frame using the received isochronous data;
(3) forming a cycle start frame used for reporting start of the super frame; and
(4) inserting the asynchronous data into an area of an asynchronous frame by employing a remaining area as the area of the asynchronous frame, the remaining area being obtained by excluding an isochronous frame area, which includes the cycle start frame and the isochronous frame, from an area having the predetermined size.

2. The method as claimed in claim 1, wherein the cycle start frame includes a destination address (DA) field used for representing a destination address, a source address (SA) field used for representing a source address, an E type field used for representing an Ethernet type, a flag field used for representing if a corresponding frame is the cycle start frame, a cycle duration field used for representing duration of the super frame, a cycle number field used for representing a cycle number of a current super frame, and a frame checksum sequence field used for detecting a transmission error of the cycle start frame.

3. The method as claimed in claim 2, wherein the cycle start frame includes a synchronization (Sync) duration field used for reporting a range of the isochronous frame area.

4. The method as claimed in claim 1, wherein the isochronous frame is formed using an Ethernet packet scheme according to Institute of Electrical and Electronics Engineers (IEEE) 802.3 protocol standards.

5. The method as claimed in claim 4, wherein a destination address of the Ethernet packet included in the isochronous frame is set as an address selected from the group consisting of: a multi-cast address and uni-cast address.

6. The method as claimed in claim 5, wherein the destination address of the Ethernet packet, which receives the isochronous frame, is set as any one of a uni-cast address and a multi-cast address according to a destination address number of the Ethernet packet included in the isochronous frame.

7. The method as claimed in claims 1, further comprising the step of:
inserting an isochronous section end frame, which is used for clearly representing end of the isochronous frame area, into the isochronous frame area.

8. The method as claimed in claim 1, wherein the residential Ethernet system inputs/outputs the super frame by performing the steps of:
parsing the input super frame received;
removing the cycle start fame contained therein and individually storing the isochronous frame and the asynchronous frame; and
adding a new cycle start frame to the stored isochronous frame and the stored asynchronous frame so as to form a second super frame by acting as a cycle master.
